(19) United States
(12) Patent Application Publication
(10) Pub. No.: US 2013/0081743 A1
(43) Pub. Date: Apr. 4, 2013

(54) Silly Treadz, Wrolly Writers, Safety Treadz, and Re-Treadz: A Separate Tire and Tread System, Which Allows for the Replacement of the Tread for any Reason

(71) Applicant: Thomas Ellis Coghill, JR., Deerfield Beach, FL (US)

(72) Inventor: Thomas Ellis Coghill, JR., Deerfield Beach, FL (US)

(21) Appl. No.: 13/475,871

(22) Filed: May 18, 2012

Related U.S. Application Data
(60) Provisional application No. 61/519,096, filed on May 18, 2011.

(51) Int. Cl. B60C 11/02

(52) U.S. Cl. CPC B60C 11/02
USPC 152/209.1

(57) ABSTRACT

The present invention is a wheel, tire and tread system that is used to change wheel diameters, change treads for varying terrains, for safety reasons, to re-tread or to tread designs. The tread designs can be used to exhibit brands, prints, imprints and they can also be used as molds. The invention is comprised of a separate tread and a separate tire to be used together. It is also comprised of a key, distinguishing factor, which are the attachments that are located on the sidewalls of these tires. These attachments allow for the separate tread and the separate tire to be used together. The present invention is used by attaching the varying treads to the varying wheels through slipping the holes on the treads into the buttons on the wheels. The pieces fit together forming one unit and function as any typical tire should.

### CROSS-REFERENCE TO RELATED APPLICATIONS

I am claiming the filing date of Provisional Application #61/519,096

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF TECHNOLOGY

Aspects of the disclosure relate to wheels. More specifically, the present invention relates to a wheel, tire and tread system and its method of use.

### BACKGROUND OF THE INVENTION

The present invention is in the technical field of wheels. More particularly, the present invention is in the technical field of a system comprised of wheels, tires and treads and the system's method of use.

Presently there exists no method to change wheel diameters without changing the wheel, rim or hub or to change the treads on a tire without changing the entire tire. There is also no system available to allow for printing, imprinting, molding or advertising through the use of treads, wheels or tires. The present invention seeks to respond to the long felt need for all of the above-mentioned issues.

### BRIEF SUMMARY OF THE INVENTION

The present invention is a wheel, tire and tread system that is used to change wheel diameters, change treads for varying terrains, for safety reasons, to re-tread or to tread designs. The tread designs can be used to exhibit brands, prints, imprints and they can also be used as molds. The invention is comprised of a separate tread and a separate tire to be used together. It is also comprised of a key, distinguishing factor, which are the attachments that are located on the sidewalls of these tires. These attachments allow for the separate tread and the separate tire to be used together. The present invention is used by attaching the varying treads to the varying wheels through slipping the holes on the treads into the buttons on the wheels. The pieces fit together forming one unit and function as any typical tire should.

### DETAILED DESCRIPTION OF THE INVENTION

The present invention is a system, which allows one to change a wheels diameter with only the change of the tire and without changing the wheel, rim or hub. This system is comprised of using attachment devices on the sidewalls of the tire to attach differing treads on the tire. The attachment devices are buttons that run all along the inner portion of the tire, namely the portion of the tire that does not touch the ground. The buttons are made to fit into holes that are all along the inner portion of the treads. This system can be adjusted to any and all types of wheels on all types of devices including but not limited to bicycles, automobiles, motorcycles, rollerblades, roller skates, skateboards and any other type of wheel. The system can be used on existing treads in addition to the system being independently used. This system allows one to change the diameter of the wheel system by only changing the tire and not the rim, spokes or hub. It can contain treads with different designs that allow one to make impressions onto soft grounds in a stamp-like fashion.

This system is further comprised of wheels that are hollowed out and that allow any type of ink or dye to be placed in the wheel. The treads in this system can be made from a material that is sponge or sponge like and can then be placed over the hollowed wheel. The treads can be any and all designs, can convey messages and can be custom made. Upon the addition of dye to the wheel, these treads will stamp the image of the tread onto any and all surfaces.

A fork-like handle can also be attached to the wheel thus making the wheel an independent stamping device and a type of toy for children of all ages. This toy will also house a fill and drain capped spout to allow one to fill the wheel with water to give it extra weight for imprinting at the beach or hot water for imprinting in the snow. The letters, designs, characters and or numbers can be changed on the wheel of the toy by simply sliding the letters, designs, characters or numbers onto the tread portion of the wheel.

Another optional use of this system is to use it to replace worn out treads for automobiles. With a simple change of treads, the wheel of an automobile can be made safe again, making the roads safe for everyone. To increase safety during travel, treads for automobiles that are made with spikes or studs can be connected to the wheels, enabling one to gain complete traction in any type of weather and on any type of terrain.

Likewise, this system comprises wheels and treads for bicycles, motorcycles and or all terrain vehicles that are made with spikes or studs enabling one to gain complete fraction in any type of weather and on any type of terrain.

This system is comprised of individual units of tires and treads or wheels, tires and treads that can be completely individual units and designs. These units can easily be removed and replaced even while on the road. These units can also allow for applying ink, dye or paint in a manner continuously to print or imprint. This system also allows prints, imprints, or molds any image desired in the reversed or mirrored image.

This system is an attachable tread system, which allows one to replace the tread at will through the use of a sidewall attachment. This system is also comprised of a rim/hub vehicle that allows for a change in the height or size of the vehicle through the change of the tires. This system also allows for a new tread to be placed over top of an already existing tread.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A system, which allows one to change a wheels diameter with only the change of the tire and without changing the wheel, rim or hub, comprising a tire or tires containing buttons along the portion of the tire that does not touch the ground, said buttons being made to fit into holes that are all along the portion of the treads that do not touch the ground, and attachment devices on the sidewalls of the tire to attach differing treads on the tire; further, this system can also be adjusted to suit any and all types of wheels on all types of devices including but not limited to bicycles, automobiles, motorcycles, rollerblades, roller skates, skateboards and any other type of wheel, and can be used on existing treads in addition to the system being used independently.

2. The system as in claim 1, further comprising an option that allows one to change the diameter of the wheel system by only changing the tire and not the rim, spokes or hub.

3. A system as in claim 1, further comprising treads with different designs that allow one to make impressions onto soft grounds in a stamp-like fashion.

4. A system as in claim 1, further comprising wheels that are hollowed out and that allow any type of ink or dye to be placed in the wheel.

5. A system as in claim 1, further comprising a tread or treads made from a material that is sponge or sponge like and that is placed over a hollowed wheel, which, upon the addition of dye to the wheel, these treads will stamp the image of the tread onto any and all surfaces.

6. A system as in claim 5, further comprising a handle that can be attached to the wheel, a fill and drain capped spout to allow one to fill the wheel with water to give it extra weight for imprinting, and pieces shaped in the form of letters, designs, characters and or numbers that are on the surface of the wheel that can be changed by simply sliding the pieces onto the tread portion of the wheel thus making the wheel an independent stamping device.

7. A system as in claim 1, further comprising treads to replace worn out treads for automobiles, motorcycles, all terrain vehicles, bicycles and any object with a tread.

8. A system as in claim 7, further comprising treads for automobiles that are made with spikes or studs enabling one to gain complete traction in any type of weather and on any type of terrain.

9. A system as in claim 7, further comprising treads for bicycles that are made with spikes or studs enabling one to gain complete traction in any type of weather and on any type of terrain.

10. A system as in claim 7, further comprising treads for motorcycles that are made with spikes or studs enabling one to gain complete traction in any type of weather and on any type of terrain.

11. A system as in claim 7, further comprising treads for all terrain vehicles that are made with spikes or studs enabling one to gain complete traction in any type of weather and on any type of terrain.

12. A system as in claims 1 and 6, further being comprised of plastic and allowing the designs to be changed by using a plastic stick to slide new images onto the wheel or wheels.

13. A system as in claim 1, further being comprised of individual units of tires and treads that can be completely individual units and designs which can easily be removed and replaced even while on the road.

14. A system as in claim 13, further comprised of a system that has separate wheels, tires and treads and which has a surface that allows the device to apply ink, dye or paint to the surface it contacts in a manner to continuously printer, imprint, or mold the configured image or its mirror image.

15. A system as in claim 13, further comprised of a system that has separate wheels, and treads and which has a surface that allows the device to continuously apply ink, dye or paint to the surface the system contacts, resulting in a print, imprint or mold of the desired image or of the mirror image.

16. A system as in claim 1, further comprised of a separate attachable tread system, which allows one to replace the tread at will through the use of the sidewall attachment.

17. A system as in claim 1, further comprised of a rim/hub vehicle that allows a change in the height or size of the vehicle through the change of the tires.

18. A system as in claim 1, further comprised of a new tread or treads that can be placed over top of the existing tread.

19. The method of use of the wheel, tire and tread system as in claims 1 through 17.

20. The method of use of attaching a new tread to an old tread as in claim 18.
